(19) United States
(12) Patent Application Publication
(10) Pub. No.: US 2026/0188707 A1
(43) Pub. Date: Jul. 2, 2026

(54) Primary Alkali Metal Cells with Cyano-Cycloalkanes Additives

(71) Applicant: LITRONIK Batterietechnologie GmbH, Pirna (DE)

(72) Inventor: Sofiane BOUAZZA, Pirna (DE)

(73) Assignee: LITRONIK Batterietechnologie GmbH, Pirna (DE)

(21) Appl. No.: 19/130,318

(22) PCT Filed: Nov. 13, 2023
(86) PCT No.: PCT/EP2023/081625

§ 371 Date: May 15, 2025

(30) Foreign Application Priority Data
Nov. 29, 2022 (EP) 22210083.6

(51) Int. Cl. H01M 6/16; H01M 4/02; H01M 4/06; H01M 4/38; H01M 4/48; H01M 4/583

(52) U.S. Cl. CPC H01M 6/168; H01M 4/06; H01M 4/382; H01M 4/483; H01M 4/5835; H01M 6/164; H01M 6/166; H01M 2004/027; H01M 2004/028; H01M 2300/004

(57) ABSTRACT

A primary cell including at least one anode, wherein the at least one anode includes an alkali metal as active anode material, at least one cathode, wherein the at least one cathode includes an active cathode material, an electrolyte, wherein the electrolyte includes at least one additive, wherein that the at least one additive is a cyano-cycloalkane of the formula

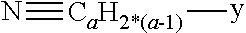

with y representing a cycloalkane with at least 3 and at most 15 C-atoms.

### CROSS-REFERENCE TO RELATED APPLICATIONS

This application is the United States National Phase under 35 U.S.C. § 371 of PCT International Patent Application No. PCT/EP2023/081625, filed on Nov. 13, 2023, which claims the benefit of European Patent Application No. 22210083.6, filed on Nov. 29, 2022, the disclosures of which are hereby incorporated by reference herein in their entireties.

### TECHNICAL FIELD

The present invention relates to a primary cell comprising at least one anode with an alkali metal as active anode material, at least one cathode comprises an active cathode material, and an electrolyte, wherein the electrolyte comprises at least one additive.

### BACKGROUND

“Primary cell” is the term for a non-rechargeable battery in the sense that the electrochemical reactions occurring while in use are irreversible. In contrast, the electrochemical reactions of a secondary cell can be reversed by running a current into the cell, thereby regenerating the respective chemical reactants.

From an ecological point of view, batteries comprising at least one secondary cell are especially favorable. However, primary cells play an important role when charging is either impractical or impossible, such as during military combat, rescue missions or implanted medical devices. Another and maybe the most important benefit of primary cells, particularly for the use in implanted medical devices, is their instant readiness even after long storage times as they show a much lower self-discharging rate. So, primary cells are the battery type of choice for applications demanding a stable performance over long periods of time. In addition, primary batteries exhibit a superior specific energy.

The use of anodes comprising an alkali metal as active anode material are considered favorable with respect to the theoretically achievable properties of the primary cell, such as high nominal voltage, high specific capacity and low self-discharge. In particular, lithium and sodium exhibit extremely high theoretical specific capacities (Li: 3860 mAh/g, Na: 1165 mAh/g), a low density (Li: 0.59 g/cm³; Na: 0.97 g/cm³) and negative electrochemical potential (Li: −3.04 V; Na: −2.71 V vs standard hydrogen electrode).

In the example of lithium, the reduction and oxidation reactions are as follows:

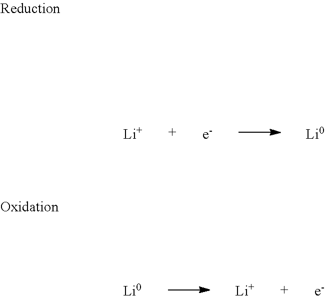 [SMILES: [Li+] ; [Li+]]

However, alkali metals are highly reactive, resulting in the formation of a passivation layer at the anode surface due to reactions with the cell electrolyte. This passivation layer is known as solid-electrolyte interphase (SEI) and significantly influences the cells performance. Since the formation of a SEI is unavoidable, the SEI is required to be sufficiently stable and electrically insulating to prevent further degradation reactions. However, the usually low ionic conductivity of the SEI results in an increase of the impedance inside the cell. Consequently, the discharge voltage and battery capacity decreases, which becomes problematic particularly in the use in medical devices.

Moreover, alkali metal cells feature another problem as formation and deposition of metallic alkali metal, e.g. lithium, on the anodic surface or the inner surfaces of the cell components including the lid, casing, collectors or cathode pin may occur. The formation of metallic alkali deposits arises if the potential of the respective component is below deposition potential of the respective alkali metal, e.g. U<0 V vs. Li/Li⁺. In this context, the term “inner surface of the cell” comprises the surfaces of the inner components that are or may come in contact with the electrolyte, including but not limited to the lid of the cell, the casing or the current collectors. This is particularly an issue in lithium metal cells.

Multiple reasons can cause this condition, e.g. due to a local increase of the Li+ ion concentration in the electrolyte. If the locally increased lithium concentration moves towards current collector or other accessible inner surface elements with anodic potential excess lithium ions can deposit to lithium metal. Moreover, an increase of the ohmic resistance may lead to a reduced anode potential, e.g. if the electric conductivity of the electrode or the ionic conductivity of the electrolyte deteriorates. The lithium depositions are irregular in a granular or dendritic form. In the worst case positive and negative compounds of the cell are being bridged causing an internal short-circuit.

To reduce lithium deposition as well as to prevent bridging of lithium clusters between negative and positive parts, insulation of the internal passive components, (e.g. cover, housing and contact parts) is often resorted to.

For example, EP 3 319 145 A1 describes an enclosure of the cathode contact parts by plastic insulating parts. The insulating parts are mainly made of polyethylene (PE), polyethylene chlorotrifluoroethylene (ECTFE or Halar); ethylene tetrafluoroethylene (ETFE), polypropylene (PP) and/or polytetrafluoroethylene (PTFE). As they are non-conductive, they prevent bridging of lithium clusters between negative and positive parts.

Instead of individual parts, U.S. Pat. No. 7,482,093 B1 provides for complete enclosure of the electrode pack and cathode contact piece from the anode components and housings. This provides more complete insulation, albeit through significant build-up.

From US 2014/0335394 A1 the use of glass wool is known, which increases the distance between negative and positive passive parts. In addition, the tortuosity of the insulating material effectively prevents the “straight line” dendrite growth of lithium clusters.

However, in any case the insulation of the internal passive components by plastic insulating part leads to a reduction of the active component volume for both anode and cathode volume. Consequently, the energy density of the cell is lowered. Furthermore, plastic insulating parts are indeed able to prevent bridging of lithium clusters between negative and positive parts, but they do not avoid lithium deposits.

Therefore, alternative attempts are directed to change the amount of electrolyte. In this context, U.S. Pat. No. 7,432,001 B1 teaches that excess electrolyte at the anode, especially its edges, leads to lithium deposition. This excess and therefore also the deposits can be prevented by reducing the amount of electrolyte. However, a reduction of the amount of electrolyte in the battery may lead to an inhomogeneous discharge of the cathode, which in turn has a negative impact on the battery properties. For the use in medical devices, the resulting uncertainty means that such batteries cannot be used easily.

Other attempts to minimize the described risks regarding lithium deposition and bridging between lithium clusters are based on the addition of additives to the electrolyte.

For example, U.S. Pat. No. 9,190,696 B2 discloses a highly concentrated non-aqueous electrolyte containing lithium conducting salt and ionic liquids. A high concentration of the conducting salt in highly viscous ionic liquid forms a quasi-solid-state electrolyte, which should prevent bridging of lithium clusters between negative and positive parts.

US 2017/0179532 A1 discloses electrolytes containing halogen-containing material such as metal halogens and/or halogen complexes for metal secondary batteries, e.g. rechargeable lithium or sodium batteries. The addition of halogens enables uniform electrodeposition of the metal like lithium or sodium on the anode and could prevent metal dendrite formation on the anode surface.

US 2015/0349380 A1 deals with rechargeable lithium-sulfur batteries with electrolyte additives according to the formula MX, whereby M corresponds to transition metals and X to anions. The disclosed electrolyte additives can form a stable passivation layer, also called Solid Electrolyte Interface Film, on the metal anodes and prevent the formation of lithium dendrites.

However, all these three additives have in common that they do not prevent lithium deposition at high currents such as in ICD application.

From the article F, Ding et. Al, J. Am. Soc. 2013, 135, 4450-4456, electrolyte additives such as CsPF6, RbPF6, ZnPF6, or RbPF6 are known for rechargeable lithium metal batteries like lithium, sodium, magnesium metal and zinc-lust batteries. The addition of Cs+, Rb+, Al3+, Zn2+, Ga3+, Un3+ and Sn2+ should prevent the chaotic growth of dendrites. Nevertheless, ionic liquid-based electrolytes have worse ionic conductivities than non-aqueous battery electrolytes.

Furthermore, U.S. Pat. No. 9,112,361 B2 teaches a combination of a number of parameters to prevent and/or reduce the growth of lithium dendrites for lithium secondary batteries. First, a special electrolyte composition with electrolyte additives, particularly lithiated polyphenoxy-polyethylene glycol, and fluorsurfactants are provided. In combination, ripple current charging is foreseen instead of constant current and/or constant voltage charging. At the same time, special programming of the battery management system (BMS) ensures that the temperature, current and voltage in the cell are limited, with particular attention on maintaining a cool atmosphere in the battery and minimizing transient currents and voltages. due to the high concentration of conductive material in the electrolyte the conductivity of the electrolyte decreases, which can lead to deterioration of the battery performance.

Finally, there are some approaches in optimizing the electrolyte for secondary cells. U.S. Pat. No. 7,871,721 B2 describes an electrolyte solvent for secondary lithium-ion batteries comprising an aliphatic mononitriles (R—C≡N) with R being a linear C₁ to C₁₅ alkane. Thereby, the protection of the cathode's surface and the stability of the electrolyte during charge/discharge cycles is improved at (very) low and high temperatures.

From U.S. Pat. No. 6,333,425 B1 malononitrile salts or malononitrile ionic compounds are known as electrolyte additives for lithium secondary batteries to improve the ionic conductivity of the electrolyte. The compounds comprise an anionic moiety combined with at least one cationic moiety, wherein M is a hydroxonium, a nitrosonium —NO+, an ammonium —NH4+, a metallic cation having valence m, an organic cation having valence m or an organometallic cation having valence m.

Mixtures of specific nitrile solvent and dinitrile solvent (such as acetonitrile, propionitrile, butyronitrile, pivalonitrile, capronitrile, malononitrile, succinitrile, glutaronitrile, adiponitrile, pimelonitrile, suberonitrile, azelanitrile and sebaconitrile) are taught in U.S. Pat. No. 9,666,906 B2 for being admixed to a high voltage electrolyte to stabilize it during charging.

However, neither of the approaches are directed to primary cells. Therefore, the additives known from prior art are not related to the problem outlined above.

The present disclosure is directed toward overcoming one or more of the above-mentioned problems, though not necessarily limited to embodiments that do.

### SUMMARY

It is, therefore, the object of the present invention to provide a primary alkali metal cell suited to be used in medium and/or high current applications while concomitantly suppressing the deposition of respective alkali metal and cathode material on the anodic surface as well as on the inner surfaces of the cell compounds.

This object is accomplished by a primary alkali metal cell with the features of current claim 1.

A primary cell according to claim 1 comprises at least one anode, wherein the at least one anode comprises an alkali metal as active anode material, at least one cathode, wherein the at least one cathode comprises an active cathode material, and an electrolyte, wherein the electrolyte comprises at least one additive.

The at least one additive is a cyano-cycloalkane of the formula

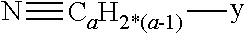

with y representing a cycloalkane with at least 3 and at most 15 C-atoms.

Surprisingly, the disadvantageous lithium depositions can be eliminated by means of this additive. Without the additive, the lithium-ion concentration on the electrode surface increases because the diffusion of the lithium in the active particles is slower than the transport of the lithium ions in the electrolyte. In other words, the mass transport of the lithium particles in the active particles is the rate-determining step.

In addition, if there is excess electrolyte at the electrode edges, the Li-ions diffuse via detours and no longer directly. The diversions of the Li ions increase the Li concentration at the staggered electrode edges and then lead to Li deposition. As a rule, the lithium anode is connected to the cover and the housing. If there is excess electrolyte between the electrode pack and passive parts (e.g. housing, cover, anode contact parts, cathode pin), the lithium concentration will increase there and lead to lithium depositions.

Against this background, the present invention enables, through the electrolyte additive for lithium metal batteries, the prevention of lithium deposition and/or the reduction of lithium dendrites and extends the lifetime of the implantable batteries as it was found that the addition of the additive to the electrolyte of a primary alkali metal cell effectively suppresses the deposition of the alkali metal on the anode surface and other inner surfaces of the cell. This observation may be explained by the formation of a stable SEI even in high rate and high current pulse discharge applications.

So, the present invention offers the advantage that not only the bridging of lithium clusters between negative and positive parts but also the formation of lithium dendrites on metallic components is prevented. Moreover, the effect of the electrolyte additives prevents lithium deposition in the entire interior of the battery.

It has been found advantageous if in the given structural formula y is representing a cycloalkane compound. Particularly preferred are the following compounds:

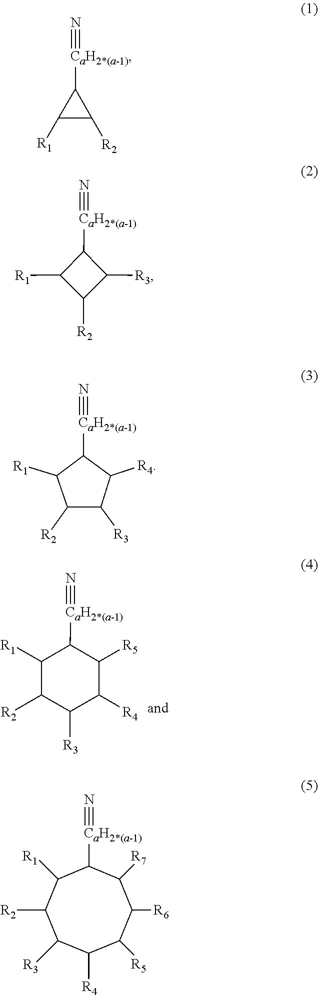

Each of these rests R₁, R₂, R₃, R₄, R₅, R₆ and R₇ may be defined as a hydrogen atom or a C₁ to C₄ alkyl group. Thereby, R₁, R₂, R₃, R₄, R₅, R₆ and R₇ are independently of each other. On the one hand, it is advantageous that the melting and boiling points of the cycloalkanes are higher than those of the comparable n-alkanes due to the symmetry and the more restricted rotation. On the other hand, the ring systems have a stabilizing effect.

In a specific embodiment, the cyano-cycloalkane is selected from the group consisting of compounds of the formula:

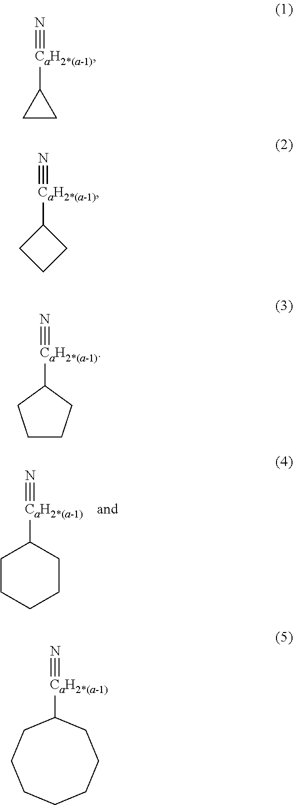

In other words, each of the groups R₁ to R₇ corresponds to a hydrogen atom. Thereby, the cycloalkane corresponds to the best known, stable and readily available compounds.

Supplementary or alternatively, the cycloalkane compound is directly connected to the nitrile, so that the running index a in the general form has the value 1. This corresponds to the following formula:

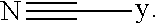

This has the advantage that practically no steric effects play a role. Furthermore, the compounds can also be synthesized particularly easily. This holds particularly true for the formulas given with regard to claims 2 and 3 which are still valid with the special case a=1 and should be explicitly disclosed:

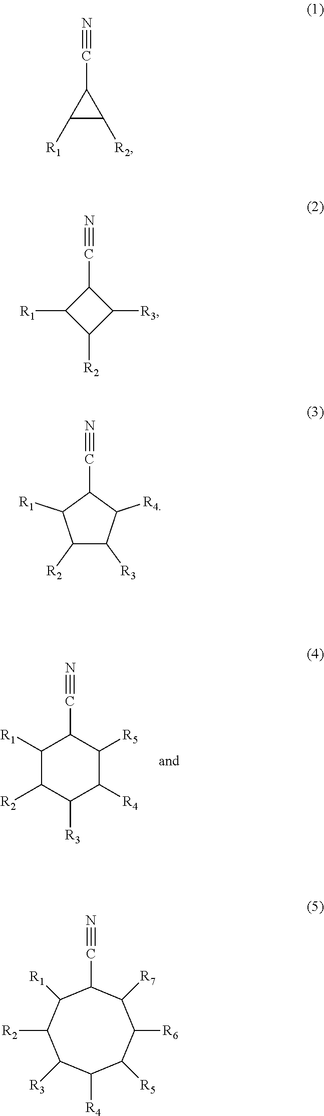

Therein, R₁, R₂, R₃, R₄, R₅, R₆ and R₇ are defined independently of each other defined as a hydrogen atom or a C₁ to C₄ alkyl group. The resulting compounds show the advantages described for the more general formulas there in a particularly pronounced way. The most positive effect is shown for cycloalkanes without any allyl groups:

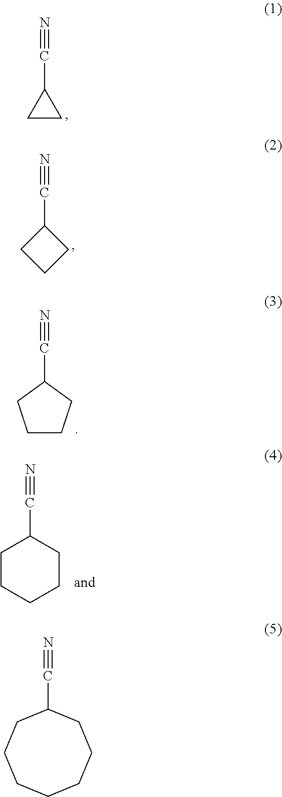

According to an embodiment the at least one additive, i.e. the c cyano-cycloalkane, has a concentration of 0.0005 mol/l to 2 mol/l, preferably 0.005 mol/l to 0.4 mol/l, most preferably 0.05 mol/l to 0.3 mol/l in the electrolyte. At concentrations below 0.0005 mol/l the beneficial effects of the cyano-cycloalkane are hardly noticeable, whereas concentrations higher than 2 mol/l do not lead to any further noteworthy decrease of the lithium deposition.

In addition to the cyano-cycloalkane as additive, the electrolyte comprises at least one solvent and may further comprise at least one conductive salt.

Suitable electrolytes include, without being restricted to, non-aqueous, preferable aprotic, solvents, such as an ester, an ether and a dialkyl carbonate, particularly tetrahydrofuran, methyl acetate, diglyme (bis(2-methoxyethyl)ether), triglyme (tris(2-methoxyethyl)ether), tetraglyme (tetra(2-methoxyethyl)ether), 1,2-dimethoxyethane, 1,2-diethoxyethane, 1-ethoxy-2-methoxyethane, dimethyl carbonate, diethyl carbonate, dipropyl carbonate, ethyl methyl carbonate, methyl propyl carbonate, ethyl propyl carbonate or a mixture thereof, or a cyclic carbonate, a cyclic ester, a cyclic amide, particularly propylene carbonate, ethylene carbonate, butylene carbonate, γ-butyrolactone, N-methyl pyrrolidinone or a mixture thereof. Suitable electrolytes also comprise polar non-aqueous solvents such as acetonitrile, dimethyl sulfoxide, dimethyl formamide, dimethyl acetamide or a mixture thereof.

The conductive salt is preferably an inorganic alkali metal salt, whereby the alkali metal cation is the same as the active anode material. Suitable anions are PF₆⁻, BF₄⁻, AsF₆⁻, SbF₆⁻, ClO₄⁻, O₂, AlCl₄⁻, GaCl₄⁻, SCN⁻, SO₃(C₆F₅)⁻, C(SO₂CF₃)₃⁻, N(SO₂CF₃)₂⁻ and SO₃CF₃ among others. In a preferred embodiment, the concentration of the conductive salt in the electrolyte is between 0.5 to 2.0 mol/l, preferably 0.8 to 1.5 mol/l.

In a preferred embodiment the alkali metal used as active anode material is metallic sodium, a sodium alloy, metallic lithium or a lithium alloy, preferably lithium or a lithium alloy. Anodes based on sodium, lithium and their alloys are especially suited due to their high theoretical specific capacities and negative electrochemical potential. Moreover, both alkali metals are cheap and readily available as compared to their heavier homologues.

The shape of the anode is not limited to a specific form. Preferably, the anode is in form of a thin sheet or foil, which is conductively connected at least on a metallic anode current collector, e.g. by pressing or welding. Further embodiments include disk-, cylindrical, rod-shaped or folded anodes.

The cathode is preferably a solid material and may comprise a metal, a metal oxide, a mixed metal oxide, a metal sulfide, carbonaceous compounds or mixtures thereof.

In a further embodiment of the invention, the active cathode material is MnO₂, silver vanadium oxide (SVO), copper silver vanadium oxide (CSVO), V₂O₂, TiS₂, CuO₂, Cu₂S, FeS, FeS₂, CFₓ (carbon fluorides), Ag₂O, Ag₂O₂, CuF, Ag₂CrO₄, CuO, copper vanadium oxide or a mixture thereof, preferably MnO₂.

If necessary, a binder material is added to the active cathode material during the preparation of the cathode. Said binders usually make up for in 1.0 to 5.0 wt % of the total cathode material mixture. Suitable materials include powdered fluoropolymers, such as polytetrafluoroethylene or polyvinylidene fluoride.

Moreover, one or more additives to improve the cathode conductivity, including graphite or carbon black, may be added to the cathode material. Preferably, these additives account for 1.0 to 15.0 wt % of the total cathode material mixture.

Preferably, the cathode is conductively connected at least on a metallic cathode current collector, which may be in form of a thin sheet of metal foil. Suitable materials are selected from but not limited to titanium, gold, stainless steel, cobalt nickel, molybdenum or steel alloys.

It is within the scope of the present invention that several primary cells are combined to a battery. A battery generally comprises at least one electrochemical cell and multiple cells may be combined in a series and/or parallel circuit. Herein, the terms cells, primary (alkali metal) cells, primary (alkali metal) batteries and batteries are considered as collective terms and used interchangeably where applicable.

In a preferred embodiment, the primary cell is a lithium metal battery comprising at least one anode with lithium as active anode material and at least one cathode with MnO₂ as active cathode material. This combination is especially attractive, since the advantages of lithium outlined above are combined with MnO₂, which is a highly stable low-cost material with high potential capacity. Whereas the nominal voltage of 3.0 V is lower than that of e.g. lithium thionylchloride (3.6 V), Li—MnO₂ achieve significantly higher currents (up to 5 A continuous load and up to 10 A pulse load).

Lithium MnO₂ cells are based on the intercalation of Li⁺ ions into the MnO₂ lattice. The underlying redox reactions are as follows:

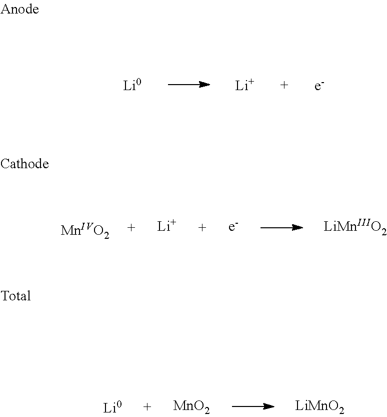 [SMILES: [Li+] ; "MnIVO2" ; [Li+] ; "LiMnIIIO2" ; "MnO2" ; "LiMnO2"]

For Li/CFx cells, the following reactions take place:

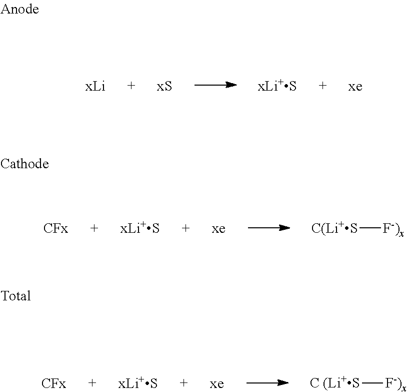

Thereby, S represents one or more solvent molecules coordinated with each Li⁺ ion.

Upon formation, the graphite intercalation compound (GIC) intermediate subsequently decomposes into the final discharge products:

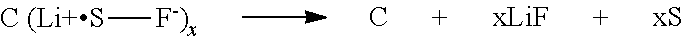

In order to avoid an internal short-circuit, the electrodes are separated by a separator made of an electrically insulative material, which is also chemically inert, i.e. does not react with the anode or cathode material, as well as the electrolyte. Nonetheless, the separator allows the diffusion of ions when moistened with the electrolyte, i.e., Li⁺ ions from the anode to the cathode during discharge. Suitable materials are polyolefines, such as polyethylene or polypropylene, or fluoropolymers, such as polyethylenetetrafluoroethylene, among others. Preferably, the separator is in form of a membrane.

The cell components are arranged within a casing, which is compatible with materials of the anode, cathode and electrolyte. The casing may comprise materials such as titanium, aluminum or stainless steel among others.

The present invention further includes the use of a primary alkali metal cell with cyano-cykloalkanes additive as an implantable battery or battery in implantable medical devices. Cardiac pacemakers, leadless pacemakers, cardioverter defibrillators (ICDs), cardiac loop recorders, drug delivery pumps or neurostimulators are examples of active implantable medical devices which are battery powered.

Accordingly, the present invention further includes an implantable battery or an implantable medical device, which comprises the primary alkali metal cell according to the invention.

Especially pacemakers and ICDs depend on batteries that allow a consistent delivery of pulses even after extended periods of inactivity. If an acute cardiac event is detected, high current pulses are delivered to prevent a possible cardiopulmonary arrest. Even when operated under such unfavorable conditions, the primary cells as according to the invention neither exhibit a considerable amount of unwanted lithium deposition nor a voltage delay.

Developments, advantages and application possibilities of the invention also emerge from the following description of the examples and the drawings. All features described and/or illustrated in the drawings form the subject matter of the invention per se or in any combination independently of their inclusion in the claims or their back references.

The following examples illustrate the current invention, but the invention is not limited by and to these examples. All examples are shown in table 1.

Primary lithium metal MnO₂ and CFₓ cells are used as model systems to determine the effect of the cyano-cycloalkane on the lithium deposition as well as a voltage. The cathode comprises MnO₂ as active cathode material, mixed with graphite (3 wt % of total composition) and carbon black (2 wt % of total composition) as conductive additives as well as polytetrafluoroethylene (3 wt % of total composition) as binder. The anode comprises metallic lithium.

TABLE 1
Composition of the electrodes

| Cathode active | | |
|---|---|---|
| material | MnO₂ | CFx |
| Conductive additives | graphite (3%) and carbon | graphite (10%) |
| (% by weight) | black (2%) | |
| Cathode binder (% by | polytetrafluoroethylene (3%) | polyvinylidenfluoride (10%) |
| weight) | | |
| Anode | Lithium | Lithium |

Basically, the electrolyte comprises LiClO₄ (1 mol/l) in a mixture of 1,2-dimethoxyethan, ethylencarbonate and propylencarbonate (ratio 4:4:2 (v/v)). Different additives were added to show the effect.

TABLE 2
Overview of the test distribution of the different variants.

| Test | Electrodes | Cell | |
|---|---|---|---|
| no. | material | type | electrolyte |
| Test 1 | Li/CFₓ | Medium- | 1M LiClO₄ (1 mol/l) in 1,2-dimethoxyethan, |
| | | Rate | ethylencarbonate and propylencarbonate (ratio |
| | | | 4:4:2 (v/v)) + cyanocyclopropane (0.05M) |
| Test 2 | Li/CFₓ | Medium- | 1M LiClO₄ (1 mol/l) in 1,2-dimethoxyethan, |
| | | Rate | ethylencarbonate and propylencarbonate (ratio |
| | | | 4:4:2 (v/v)). |
| Test 3 | Li/MnO₂ | Medium- | 1M LiClO₄ (1 mol/l) in 1,2-dimethoxyethan, |
| | | Rate | ethylencarbonate and propylencarbonate (ratio |
| | | | 4:4:2 (v/v)) + cyanocyclopropane (0.05M)) |
| Test 4 | Li/MnO₂ | Medium- | 1M LiClO₄ (1 mol/l) in 1,2-dimethoxyethan, |
| | | Rate | ethylencarbonate and propylencarbonate (ratio |
| | | | 4:4:2 (v/v)) |
| Test 5 | Li/MnO₂ | High- | 1M LiClO₄ (1 mol/l) in 1,2-dimethoxyethan, |
| | | Rate | ethylencarbonate and propylencarbonate (ratio |
| | | | 4:4:2 (v/v)) + cyanocyclopropane (0.05M) |
| Test 6 | Li/MnO₂ | High- | 1M LiClO₄ (1 mol/l) in 1,2-dimethoxyethan, |
| | | Rate | ethylencarbonate and propylencarbonate (ratio |
| | | | 4:4:2 (v/v)) |

To provoke the deposition of metallic lithium on the electrodes as well as on the metallic passive parts, such as the lid or housing surface, the HR batteries and MR were loaded with 25 pulses (current density: 39 mA/cm²; pulse duration: 10 s; pause between pulses 15 s) per day up to 1 V (similar to the examples given in U.S. Pat. No. 7,432,001 B1). The batteries were then opened and the area of the lithium deposits on the lid area was determined using a microscope. The obtained results are explained with regard to the figures.

Additional features, aspects, objects, advantages, and possible applications of the present disclosure will become apparent from a study of the exemplary embodiments and examples described below, in combination with the Figures and the appended claims.

### BRIEF DESCRIPTION OF THE DRAWINGS

In the figures:

FIG. 1 is a graph showing an illustrative pulse discharge curve of a primary cell according to test 1,

FIG. 2 is a graph showing an illustrative pulse discharge curve of a primary cell according to test 2,

FIG. 3 is a graph showing an illustrative pulse discharge curve of a primary cell as according to test 3,

FIG. 4 is a graph showing an illustrative pulse discharge curve of a primary cell as according to test 4,

FIG. 5 is a graph showing an illustrative pulse discharge curve of a primary cell as according to test 5,

FIG. 6 is a graph showing an illustrative pulse discharge curve of a primary cell as according to test 6,

FIG. 7 shows the amount of deposited lithium comparing tests 1 and 2 with each other,

FIG. 8 shows the amount of deposited lithium comparing tests 3 and 4 with each other and

FIG. 9 shows the amount of deposited lithium comparing tests 5 and 6 with each other.

### DETAILED DESCRIPTION

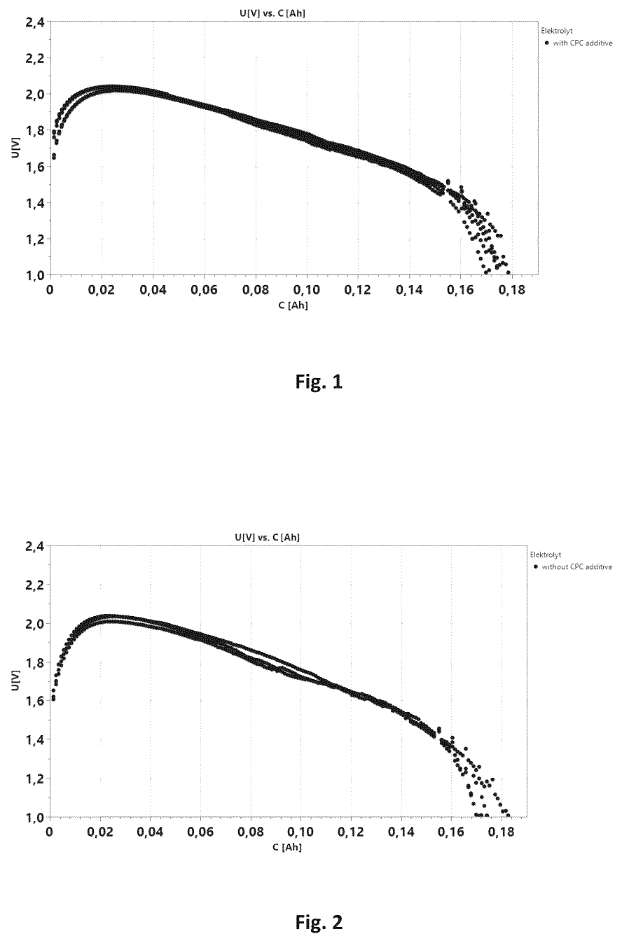

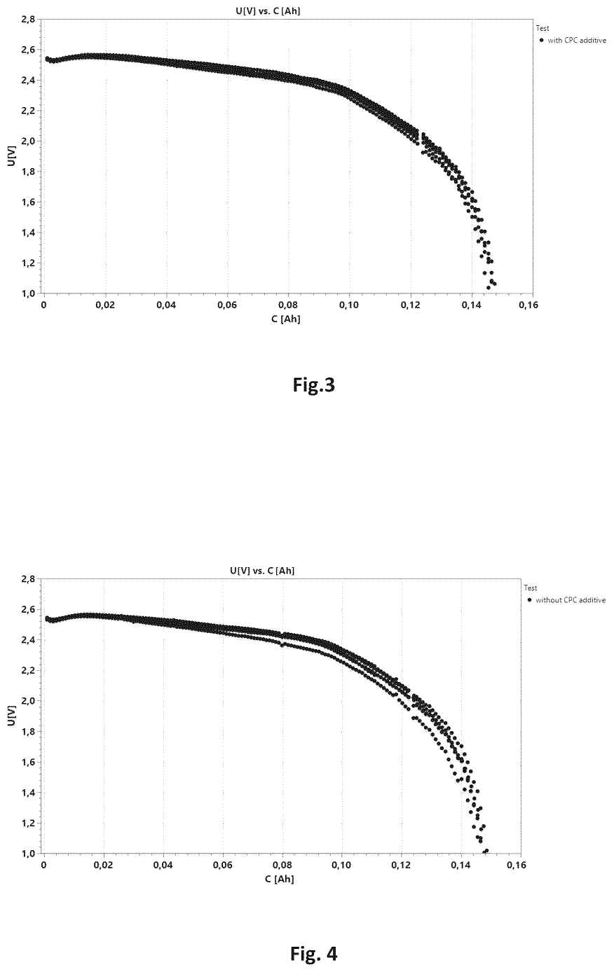

The graphs depicted in FIG. 1 to 6 show the pulse discharge curves of primary cells as according to tests 1 to 6.

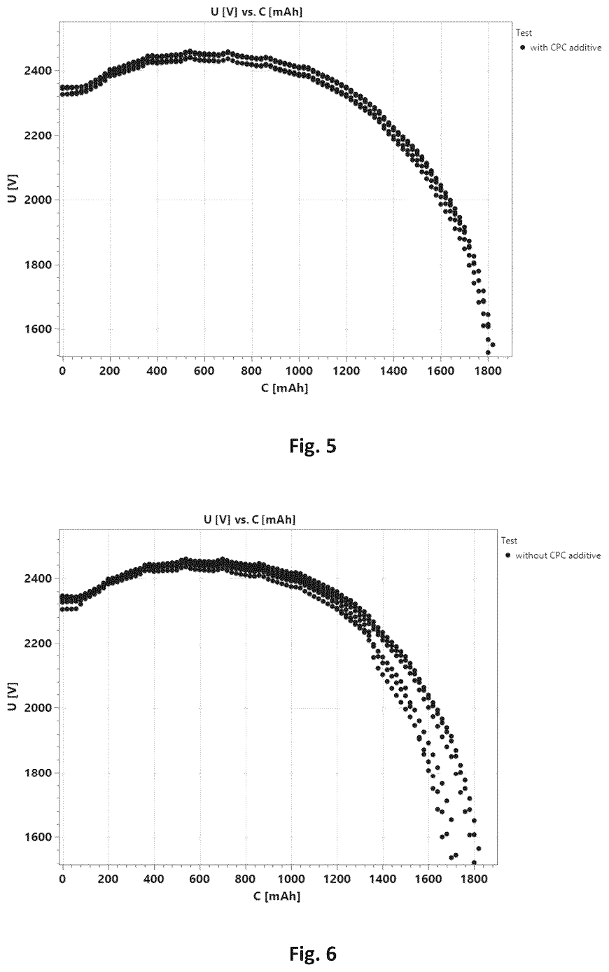

First, the obtained results should be discussed in detail by explaining FIG. 1. Therein, the initial average voltage is about 1.7 V, which subsequently rises to reach a maximum of approximately 2.0 to 2.05 V after around 20 mAh. This initial increase can be explained by the progressing formation of the conductive graphite (discharge product of the CFx), respectively, during the initial pulse trains. Moreover, a relatively sharp drop is observed for all cells, particularly, for the high rate cells in FIGS. 5 and 6. This observation may be attributed to an excessive deposition of metallic lithium resulting in a bridging of the anode and another metallic component of the cell. Consequently, the cell gets drained due to an internal short-circuit.

After reaching its maximum the measured voltage drops only slowly initially, thus creating a long period of little linear dropping between 20 and 150 mAh. During this plateau phase the cell's output remains predictable. After 140 mAh, the voltage falls below the initial voltage and after 150 mAH, the drop in voltage subsequently accelerates until the cutoff voltage of 1.0 V is reached at around 1700 to 1800 mAh, which denoted the end of life of the respective cell.

The same behavior can be found in FIG. 2 representing the measurement for a Li/CFₓ medium rate cell which, however, does not contain any additive and at least an additive according to the invention.

It becomes immediately obvious, that the presence of a cyano-cycloalkane as according to the invention reproducibly leads to a near-identical behavior of each individual cell, i.e. the individual discharge curves differ only by a small margin.

A comparison of test 3 and 4 (Li/MnO₂ medium rate cell) shows the same basic picture, even if the concrete values here are somewhat different as only a very small maximum occurs around 10 mAh and the dropping starts around 100 mAh until it reaches 1.0 V at 150 mAh.

For the Li/MnO₂ high rate cell of tests 5 and 6, depicted in FIGS. 5 and 6, obviously a plateau above 2.4 V occurs between 100 and 1000 mAh, while the lower limit of 1500 V is reached at 1800 mAh

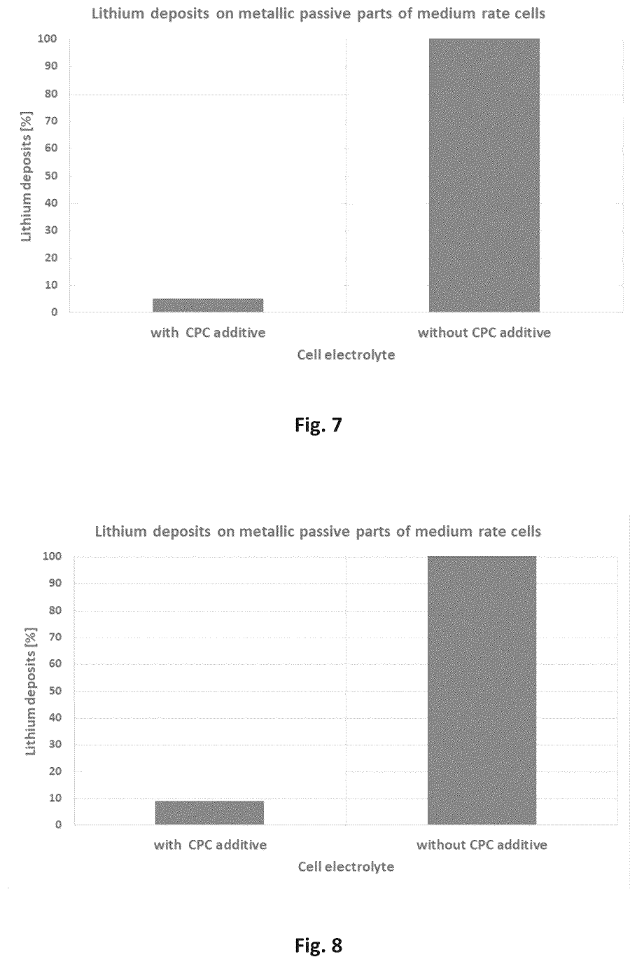

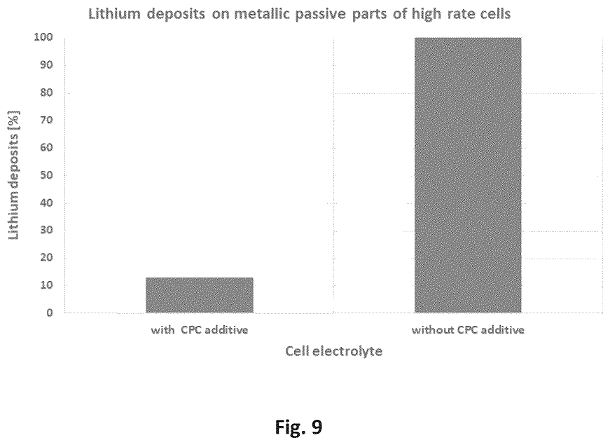

FIGS. 7, 8 and 9 show the total amounts of deposited lithium on the inner lid surface, the inner housing surface and contact components of cells according to tests 1 to 6. Each of the three figures always shows the comparison of a specific cell with and without additive. In detail, FIG. 7 shows the comparison for a Li/CF_{X} medium rate cell with and without additive, FIG. 8 the comparison for a Li/MnO₂ medium rate cell with and without additive and FIG. 9 the comparison for a LiMnO₂ high rate cell with and without additive,

The beneficial effect of the additive becomes immediately obvious in all cases. Whereas the primary cells featuring a cyano-cycloalkane exhibit hardly any lithium deposition even after the testing period, the comparative cells 16 to 20, thus exceeding cells, show at least ten times as much deposition.

The presented results clearly show that cyano-cycloalkane used as an electrolyte additive according to the invention strongly reduces or even prevents the deposition of metallic lithium on the inner surfaces of a primary cell. Moreover, bridging of lithium clusters between negative and positive parts and, therefore, battery short circuits are avoided reliably.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. A primary cell comprising at least one anode, wherein the at least one anode comprises an alkali metal as active anode material, at least one cathode, wherein the at least one cathode comprises an active cathode material, an electrolyte, wherein the electrolyte comprises at least one additive, wherein the at least one additive is a cyano-cycloalkane of the formula 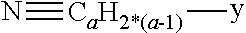
with y representing a cycloalkane with at least 3 and at most 15 C-atoms.

2. A primary cell according to claim 1, wherein the cyano-cycloalkane is selected from the group consisting of compound of the formula: 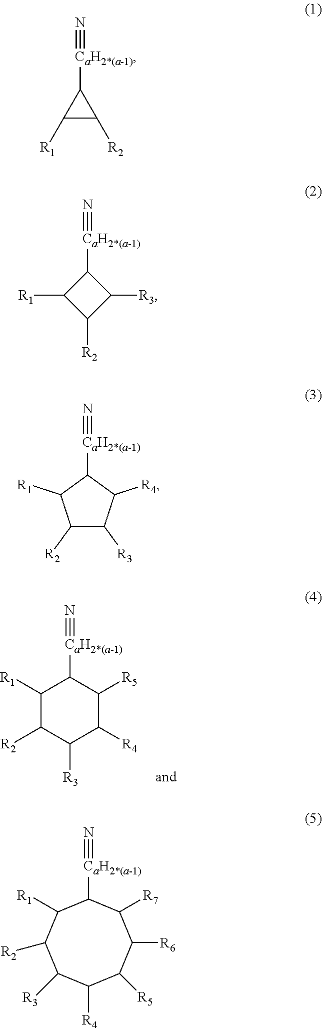
whereby R₁, R₂, R₃, R₄, R₅, R₆ and R₇ independently of each other are a hydrogen atom or a C₁ to C₄ alkyl group.

3. A primary cell according to claim 2, wherein the cyano-cycloalkane is selected from the group consisting of compound of the formula:

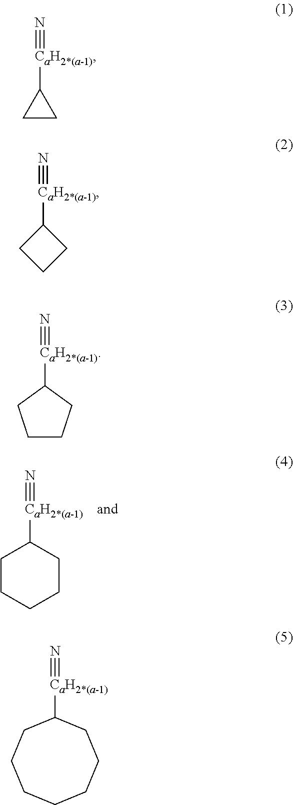

4. A primary cell according to claim 1, wherein the at least one additive is a cyano-cycloalkane of the formula 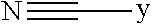
with y representing a cycloalkane with at least 3 and at most 15 C-atoms.

5. A primary cell according to claim 1, wherein the at least one additive has a concentration of 0.0005 mol/l to 2 mol/l, preferably 0.005 mol/l to 0.4 mol/l, most preferably 0.05 mol/l to 0.3 mol/l in the electrolyte.

6. A primary cell according to claim 1, wherein the active cathode material is a solid material comprising a metal, a metal oxide, a mixed metal oxide, a metal sulfide, a metal fluoride, carbonaceous compounds or mixtures thereof, preferably comprising MnO₂, silver vanadium oxid (SVO), copper silver vanadium oxide (CSVO), V₂O₂, TiS₂, CuO₂, Cu₂S, FeS, FeS₂, CFₓ, Ag₂O, Ag₂O₂, CuF, Ag₂CrO₄, CuO, copper vanadium oxide or a mixture thereof, particularly preferably comprising MnO₂.

7. A primary cell according to claim 1, wherein the primary cell is a lithium metal battery comprising at least one anode with lithium as active anode material and at least one cathode with MnO₂ or CFx as active cathode material.

8. A primary cell according to claim 1, wherein the electrolyte comprises at least one solvent and may further comprise at least one conductive salt, in particular an ester, an ether, a dialkyl carbonate, acetonitrile, dimethyl sulfoxide, dimethyl formamide, dimethyl acetamide or a mixture thereof.

9. A primary cell according to claim 8, wherein the electrolyte comprises at least one conductive salt.

10. A primary cell according to claim 9, wherein the electrolyte comprises at least one inorganic alkali metal salt, one conductive salt, whereby the alkali metal cation is the same as the active anode material.

11. A primary cell according to claim 9, wherein concentration of the conductive salt in the electrolyte is between 0.5 to 2.0 mol/l, preferably 0.8 to 1.5 mol/l.

12. A primary cell according to claim 1, wherein at least one separator is arranged between the anode and the cathode.

13. Use of a primary cell according to claim 1 as an implantable battery or battery in implantable medical devices.

14. Implantable battery comprising a primary cell according to claim 1.

15. Implantable medical device comprising a primary cell according to claim 1.
